(19) United States
(12) Patent Application Publication
(10) Pub. No.: US 2009/0066334 A1
(43) Pub. Date: Mar. 12, 2009

(54) Short Normal Electrical Measurement Using an EM-Transmitter

(75) Inventor: Andreas Peter, Cell (DE)

Correspondence Address: MADAN, MOSSMAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 12/204,090

(22) Filed: Sep. 4, 2008

Related U.S. Application Data
(60) Provisional application No. 60/971,028, filed on Sep. 10, 2007.

(51) Int. Cl. G01V 3/18

(52) U.S. Cl. 324/333

(57) ABSTRACT

A method and apparatus for determination of a formation resistivity property in which an impedance of a downhole antenna that includes an upper gap sub insulated from a lower sub is used as an estimate of the formation resistivity property.

### CROSS-REFERENCES TO RELATED APPLICATIONS

This application claims priority from U.S. Provisional Patent Application Ser. No. 60/971,028 filed on Sep. 10, 2007.

### BACKGROUND OF THE DISCLOSURE

1. Field of the Disclosure

The present disclosure relates to drilling wellbores. The present disclosure provides an apparatus and method for locating an interface between formation layers during drilling.

2. Description of the Related Art

In the drilling of oil and gas wells, it is important to be able to transmit information gathered by measurement sensors located at the bottom of the well to the surface. The measurement sensors supply useful data regarding pressure, the nature of the solids and fluids encountered, the temperature, formation properties, formation fluid content, etc. Among other things, this data is useful to an operator at the surface in determining subsequent drilling procedures, such as in planning a wellbore path. It is also important to be able to transmit orders from the surface downhole in order to control various equipment and devices such as valves, protective covers, etc. which are at the bottom of the well.

Various methods have been used in order to transmit information between a downhole apparatus and a surface location. One exemplary method uses standard electrical communication methods to transmit information along cable connections between different segments of drill pipes used in drilling operations. These methods are expensive because they require drill pipes with special wiring. In addition, due to the harsh environments encountered in typical drilling operations, it is difficult to ensure electrical continuity of the communication link. Another method of transmitting data uses mud pulse telemetry in which information is communicated via variations in pressure and/or flow rate of drilling mud. The bandwidth of mud pulse telemetry is extremely limited and is unsuited for transmitting large amounts of data. Electromagnetic transmission devices have also been used for telemetry during drilling operations.

One issue of importance in wellbore drilling is quickly and accurately relaying information to an operator at a surface location. In general, there is a time delay for information to reach a surface controller and be processed. During this time delay, a drill string can be drilling the wellbore along an unnecessary or undesired path. An operator with real-time knowledge of the formation at the drill bit can take measures to prevent such unnecessary drilling. Thus there is a need for a method of quickly obtaining formation information at a surface location.

### SUMMARY OF THE DISCLOSURE

One embodiment of the disclosure is an apparatus for estimating a property of an earth formation. The apparatus includes: a bottomhole assembly (BHA) configured to be conveyed into a borehole, the BHA comprising an upper sub and a lower sub electrically insulated from each other; and at least one processor configured to estimate a resistivity property of the earth formation using a measured impedance between the upper sub and the lower sub.

Another embodiment of the disclosure is a method of estimating a property of an earth formation. The method includes: conveying a bottomhole assembly (BHA) into a borehole; measuring an impedance between an upper sub and a lower sub on the BHA, the upper sub and the lower sub being electrically insulated from each other; and estimating a resistivity property of the earth formation using the measured impedance between the upper sub and the lower sub.

Another embodiment of the disclosure is a computer-readable medium accessible to a processor. The computer-readable medium includes instructions which enable the processor to estimate a resistivity property of an earth formation, using an impedance measurement between an upper sub and a lower sub electrically insulated from the upper sub on a bottomhole assembly.

### BRIEF DESCRIPTION OF THE DRAWINGS

The present disclosure may be best understood by reference to the following figures in which like numerals refer to like elements, and in which:

FIG. 1 (Prior Art) is an elevational view partially in cross-section of a conventional off-shore drilling system employing a conventional electromagnetic method of information transmission using an insulating junction between one drill pipe and another drill pipe incorporating a drill bit;

FIG. 2 (Prior Art) is a side, cross-sectional view of a lower portion of the drill string shown in FIG. 1;

FIG. 3 shows an equivalent schematic circuit of a gap sub transmitter used as a resistivity measuring device; and

FIG. 4 (Prior Art) shows an exemplary electrical configuration of a short normal resistivity instrument.

### DETAILED DESCRIPTION OF THE DISCLOSURE

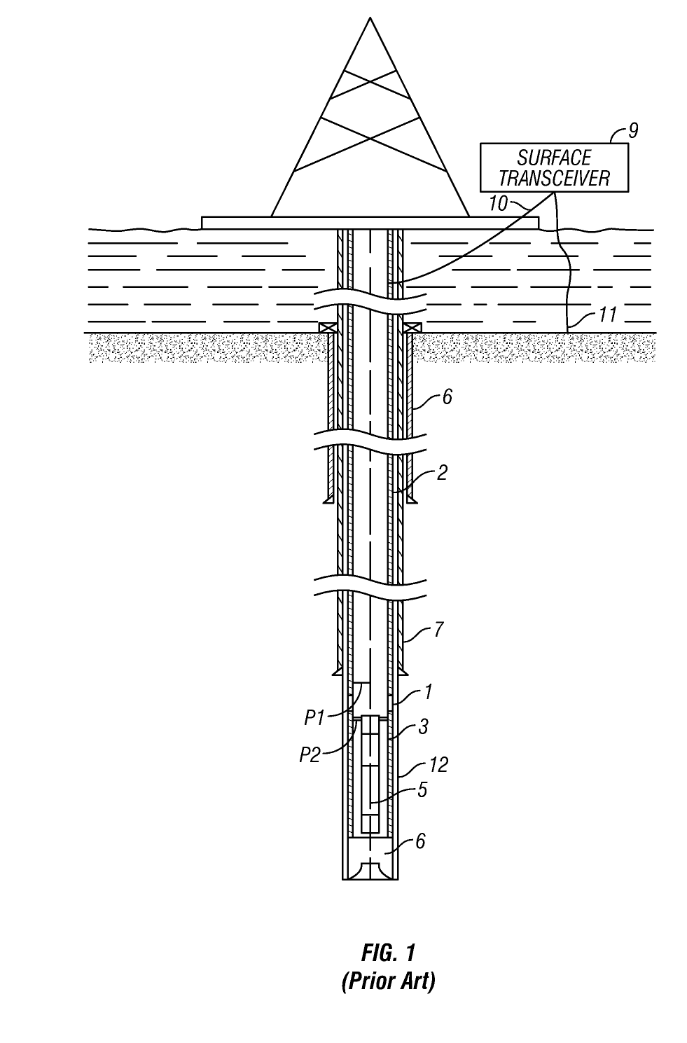

FIG. 1 illustrates a conventional measurement-while-drilling (MWD) device used for real-time measurement during drilling. A conventional dipole antenna system is formed by an electrically insulating junction 1 which insulates an upper part 2 of a drill string from a lower part 3. The lower part 3 incorporates a terminal pipe equipped with a drill bit 4.

Inside of the drill string is a cylindrical element 5 enclosing, in a conventional manner, sensors, an electronic unit, and an energy source such as batteries. A modulated low frequency alternating electric signal is delivered between an upper pole P₁.and a lower pole P₂.located on the drill string incorporating the bit 4. The modulated signal, which modulates at several hertz, encodes measurements performed by the sensors. The applied current has a value of several amps under a voltage of several volts.

The signal applied between the poles P₁ and P₂ produces an electromagnetic signal propagating in the earth formation. The electromagnetic signal is guided by the metal pipework formed by the upper string 2 and successive casings 6 and 7. The open hole portion of the drill string is designated by reference numeral 12 below casing 7. The electromagnetic signal is guided by the metal pipework and is sent to the surface where it is collected by a transceiver 9. The transceiver 9 is connected first to the mass of a drilling apparatus 10, or to a well head, or to any other pipe in the well, and second to electrical ground 11 positioned as far away as possible from the well. In off-shore installations, the electrical ground is generally at the bottom of the ocean.

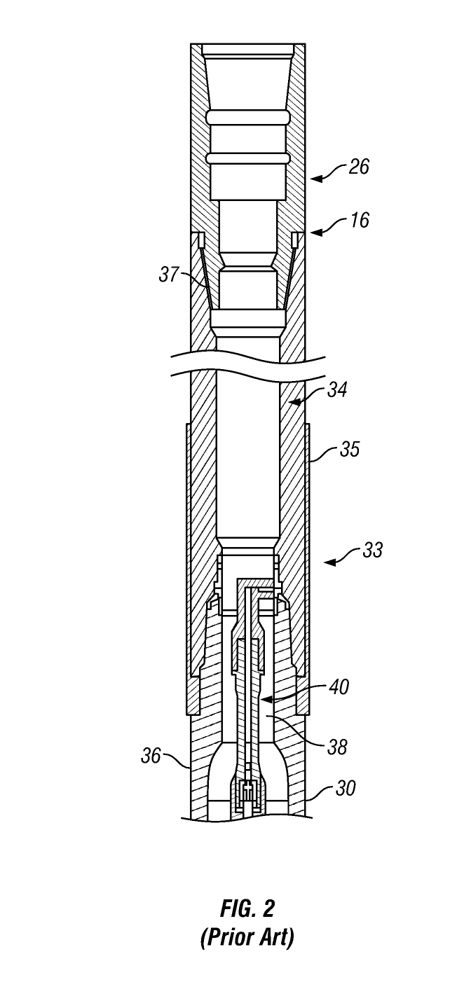

FIG. 2 provides a detailed view of lower portions of the drill string 2 (FIG. 1), including the upper portion of the MWD tool 30. The lower portion (not shown) of the MWD tool 30 includes a transmitter (not shown) which is used to transmit received data to the receiver 9 (FIG. 1). The transmitter is of a type known in the art. Suitable MWD tools for use of the tool 30 include the NaviTrak® I and Navitrak® II, which are available commercially from Baker Hughes Incorporated. As both FIGS. 1 and 2 illustrate, a gap sub assembly 33 includes upper and lower subs 34 and 36, respectively, which separate the MWD tool 30 from the lowest drill pipe section 26. The upper sub 34 is also often referred to as a gap sub. The upper sub 34 is a metallic, conductive member with an electrically insulative coating upon its entire inner and outer radial surfaces and axial ends except upon the upper threads 37. The insulative coating is a poor conductor of electricity. The upper sub 34 connects to drill string section 26 by upper threads 37 and as otherwise noted herein. An external stabilizing collar 35 radially surrounds portions of the upper and lower subs 34, 36 and serves to protect the insulated coating on the outer radial surface of the gap sub 34 from being damaged or rubbed off by contact with the wellbore. The lower sub 36 defines a borespace 38 within. The lower sub 36 may be formed integrally with the outer housing of the MWD tool 30.

The telemetry method of the present disclosure uses a gap sub assembly that incorporates upper (gap) sub 34 and lower sub 36 having an insulated interconnection. A central conductor assembly is axially disposed within the lower sub 36 and does not extend through the length of the gap sub 34. The central conductor assembly is used to transmit electrical power and data across the gap sub assembly between the upper portions of the drill string and transmitter components housed within the MWD tool disposed below the gap sub assembly. See, for example, U.S. Pat. No. 6,926,098 to Peter, having the same assignee as the present disclosure and the contents of which are incorporated herein by reference.

In operation, the gap sub assembly 33 electrically isolates the MWD tool 30 from the upper drill string pipe sections 26. At the same time, an electrical signal may be passed between the central components housed within the MWD tool 30 and both of the separated poles of a dipole antenna formed within the drill string 16. Details of the gap sub assembly are discussed in U.S. Pat. No. 6,926,098 to Peter having the same assignee as the present disclosure and the contents of which are incorporated herein by reference. One pole of the dipole antenna is provided by the lower sub 36, via the ground connection of the MWD components with the lower sub 36. The other pole is provided by upper sub 34 and the interconnected remainder of drill string 2 (FIG. 1). A signal may be transmitted from the MWD components to the upper gap sub 34 via an internal electrical pathway (discussed in detail in Peter). In one aspect, the MWD components may be operated to produce a signal that may be transmitted by this antenna and detected by the receiver 9 at the surface.

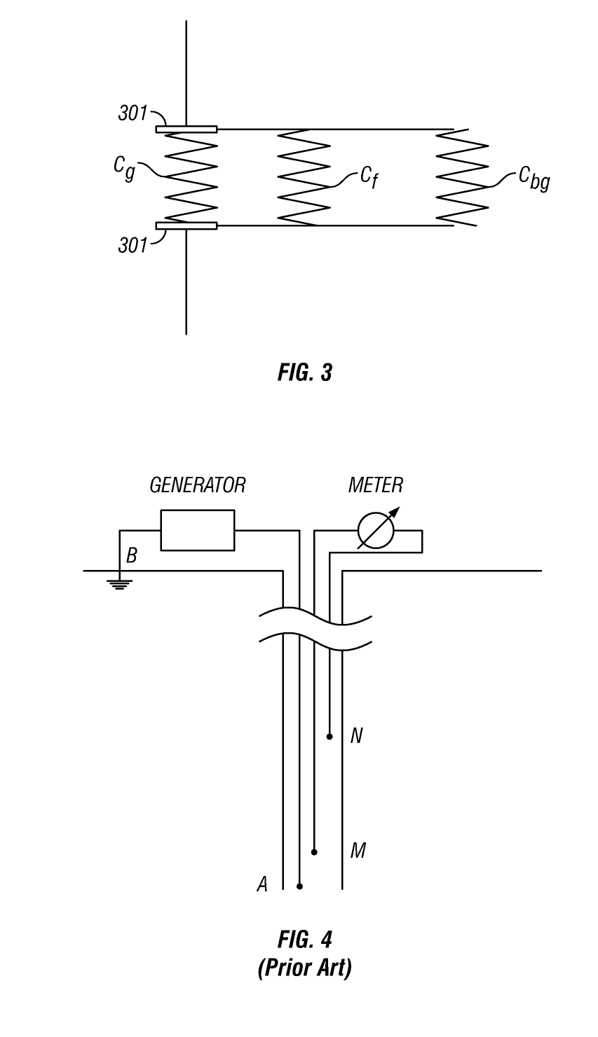

Turning now to FIG. 3, an equivalent schematic circuit of the dipole antenna is shown. The two poles of the dipole antenna are denoted by 301, 303. The term C_{g} denotes the conductivity of the gap, C_{f} denotes the conductivity of the drilled formation in the immediate vicinity of the gap sub, and C_{bg} denotes a background conductivity of the formation. It would be clear to those skilled in the art and having benefit of the present disclosure that, firstly, due to the extremely low conductance (high resistance) of the gap, the measured conductance of the gap is dominated by the conductance of the formation being drilled and the background conductance. Secondly, changes in the background conductance will be gradual while the drill string is being moved through the borehole, either while drilling or while tripping. Hence by monitoring the conductance (or resistance) of the gap, an estimate may be made of changes in the formation resistivity properties.

Those versed in the art and having benefit of the present disclosure would recognize that the equivalent electrical circuit is similar to that used in short normal resistivity measurement used in wireline logging. FIG. 4 shows an exemplary system used for short normal resistivity measurements. In the short normal method, a voltage is measured between electrode M and a reference electrode N. In the present instance, the electrode M corresponds to the upper sub, and the reference electrode N may be at a suitable location on the drillstring or at a surface location such as 11 (FIG. 1). A current is measured for electrode A, which, in the present instance, would be the lower sub. The measured resistivity (or conductivity) corresponds to a point midway between the two electrodes, A and M. In one embodiment of the disclosure, these voltages and currents may be measured using suitable voltage and current sensors.

For electromagnetic signal transmission, an electrical voltage is applied across this gap. The voltage is modulated in order to carry information to a remote location, e.g. the earth's surface, where an antenna picks up the signal. A computer or processor de-modulates the signal, so that the information of the signal can be used. The impedance measured across the gap may be influenced by several parameters: the insulation quality of the gap sub itself, the conductivity of the drilling fluid inside and around the sub, the temperature, cuttings passing the gap in the wellbore annulus, noise created by the drilling process and the conductivity of the drilled formation. In the past, the impedance across the gap has been measured in order to use this information as a kind of quality control for the integrity of the gap sub and its insulating quality. See Houston & Gablemann “Deeper, Smarter EM drilling technology”, GastTIPS, Winter 2006. If the gap sub does not change its insulation quality, and all other influencing parameters are either kept constant, or are measured independently, then the impedance across the gap length is only influenced by the formation conductivity, or resistivity. If the BHA is tripped out after drilling is finished for the current section, then the measured impedance across the gap is a very close representation of the formation resistivity, since there is no drilling induced noise and the drilling fluid conductivity does not change much in the relatively short time frame. The cuttings passing the gap do not provide a big influence on the measured impedance, and the temperature can be measured for correction purposes. The obtained log is very similar to the well known short normal wireline measurement.

The present disclosure comes at low cost, since no additional equipment is required and measurements may be made while tripping without additional rig time. The gap sub and the impedance measuring circuit are already part of a BHA that uses EM telemetry, and can easily be used for implementing the method discussed above. In one aspect, the described measurement of the impedance across the gap while drilling can be stored in a memory inside the downhole tool. Once the tool is back on the surface, the measurements stored in memory can be downloaded and used to create a log of the borehole resistivity characteristics. Alternatively, some or all of the measurements may be transmitted to surface while drilling continues. This way it can be used to provide information as a basis for drilling decisions.

The information being telemetered to the surface may be the output of a formation evaluation sensor, such as an acoustic sensor, a nuclear magnetic resonance sensor, a nuclear sensor such as a gamma ray sensor or a neutron sensor, a resistivity sensor. The information being telemetered to the surface may also include the output of a sensor responsive to a drilling condition, such as vibration. The information being telemetered to the surface may also include survey information from an accelerometer or a gyroscope.

In an alternative embodiment, the gap sub can be used to obtain information about the formation resistivity characteristics in real time, without measuring the impedance across the gap length downhole. The signal strength is measured by the surface de-modulation antenna. The signal strength is influenced by the conductivity of the formations that are penetrated as drilling takes place. The signal strength measured at the surface varies with changing formation conductivity around the gap. The measured signal strength at the surface also varies when the drill bit contacts a formation with a different resistivity than before. Since the measurement is made at the surface, this information is available instantaneously. There is no need for data transmission and its inherent time delay. In the alternative embodiment, a surface detector may be used, e.g. to stop drilling immediately when an abrupt change in measured signal strength at the surface indicates the penetration of a formation that needs to be avoided. The damage to the reservoir using the method of the present disclosure is potentially smaller than the damage resulting from a “stop drilling” decision based upon gamma ray measurements or propagation resistivity measurements. Gamma ray detectors and propagation resistivity tools are commonly mounted several meters behind the bit, increasing the likelihood of drilling into the wrong formation before the damage is noticed. Also, propagation resistivity tools are also not commonly used in low cost applications which are typically used for EM telemetry-based MWD devices.

The processing of the data may be accomplished by a downhole processor and/or a surface processor. Implicit in the control and processing of the data is the use of a computer program implemented on a suitable machine readable medium that enables the processor to perform the control and processing. The machine readable medium may include ROMs, EPROMs, EAROMs, Flash Memories and Optical disks.

While the foregoing disclosure is directed to the specific embodiments of the disclosure, various modifications will be apparent to those skilled in the art. It is intended that all such variations within the scope and spirit of the appended claims be embraced by the foregoing disclosure.

What is claimed is:

1. An apparatus for estimating a property of an earth formation, the apparatus comprising:
a bottomhole assembly (BHA) configured to be conveyed into a borehole, the BHA comprising an upper sub and a lower sub electrically insulated from each other; and
at least one processor configured to estimate a resistivity property of the earth formation using a measured impedance between the upper sub and the lower sub.

2. The apparatus of claim 1 further comprising a resistivity sensor configured to measure the impedance between the upper sub and the lower sub.

3. The apparatus of claim 1 further comprising a gap sub between the upper sub and the lower sub configured to generate an electromagnetic signal and wherein the at least one processor is configured to use an amplitude of the electromagnetic signal at a surface location to provide an estimate of the resistivity.

4. The apparatus of claim 1 wherein the BHA is configured to be conveyed on a drilling tubular and the apparatus is configured to make measurements during at least one of: (i) drilling operations, and (ii) tripping out of the borehole.

5. The apparatus of claim 4 wherein a surface processor is configured to provide an alarm signal when there is an abrupt change in the strength of the EM signal.

6. A method of estimating a property of an earth formation, the method comprising:
conveying a bottomhole assembly (BHA) into a borehole;
measuring an impedance between an upper sub and a lower sub on the BHA, the upper sub and the lower sub being electrically insulated from each other; and
estimating a resistivity property of the earth formation using the measured impedance between the upper sub and the lower sub.

7. The method of claim 6 further comprising using a resistivity sensor to measure the impedance between the upper sub and the lower sub.

8. The method of claim 6 further comprising using a gap sub between the upper sub and the lower sub to generate an electromagnetic signal, and using an amplitude of the electromagnetic signal at a surface location to provide an estimate of a resistivity property.

9. The method of claim 6 further comprising conveying the BHA on a drilling tubular and making measurements during at least one of: (i) drilling operations, and (ii) tripping out of the borehole.

10. The method of claim 9 further comprising providing an alarm signal when there is an abrupt change in the strength of the EM signal.

11. A computer-readable medium accessible to a processor, the computer-readable medium including instructions which enable the processor to estimate a resistivity property of an earth formation, using an impedance measurement between an upper sub and a lower sub electrically insulated from the upper sub on a bottomhole assembly.

12. The computer-readable medium of claim 11 further comprising at least one of: (i) a ROM, (ii) an EPROM, (iii) an EAROM, (iv) a flash memory, and (v) an Optical disk.
